(19) United States
(12) Patent Application Publication
(10) Pub. No.: US 2011/0111732 A1
(43) Pub. Date: May 12, 2011

(54) METHOD AND APPARATUS FOR DYNAMIC PROVISION OF PERSONALIZED INFORMATION

(76) Inventor: VENSON SHAW, Kirkland, WA (US)

(21) Appl. No.: 12/613,600

(22) Filed: Nov. 6, 2009

(51) Int. Cl. H04L 12/58; H04W 4/12

(52) U.S. Cl. 455/412.1; 455/466

(57) ABSTRACT

In one embodiment, the present disclosure is a method and apparatus for dynamic provision of personalized information. In one embodiment, a method for providing information relevant to a need of a user of a communication device includes monitoring, by the communication device, dynamic information relating to the user, and sending, by the communication device, a message describing the need of the user, where the message includes the dynamic information.

### FIELD OF THE INVENTION

The present invention relates generally to telecommunications and relates more particularly to the dynamic provision of personalized information.

### SUMMARY OF THE INVENTION

In one embodiment, the present disclosure is a method and apparatus for dynamic provision of personalized information. In one embodiment, a method for providing information relevant to a need of a user of a communication device includes monitoring, by the communication device, dynamic information relating to the user, and sending, by the communication device, a message describing the need of the user, where the message includes the dynamic information.

### BRIEF DESCRIPTION OF THE DRAWINGS

The teaching of the present disclosure can be readily understood by considering the following detailed description in conjunction with the accompanying drawings, in which:

FIG. 1 is a schematic diagram illustrating one embodiment of a system for providing personalized information in a dynamic manner, according to the present invention;

FIG. 2 is a flow diagram illustrating one embodiment of a method for dynamically providing personalized information;

FIG. 3 is a flow diagram illustrating one embodiment of a method for dynamically providing personalized information; and

FIG. 4 is a high level block diagram of the information providing method that is implemented using a general purpose computing device.

To facilitate understanding, identical reference numerals have been used, where possible, to designate identical elements that are common to the figures.

### DETAILED DESCRIPTION

In one embodiment, the present invention is a method and apparatus for dynamic provision of personalized information. Embodiments of the invention allow users to broadcast their needs and to receive relevant advertisements responsive to the broadcasted needs. In this way, the users can obtain relevant, time-sensitive information in a dynamic manner.

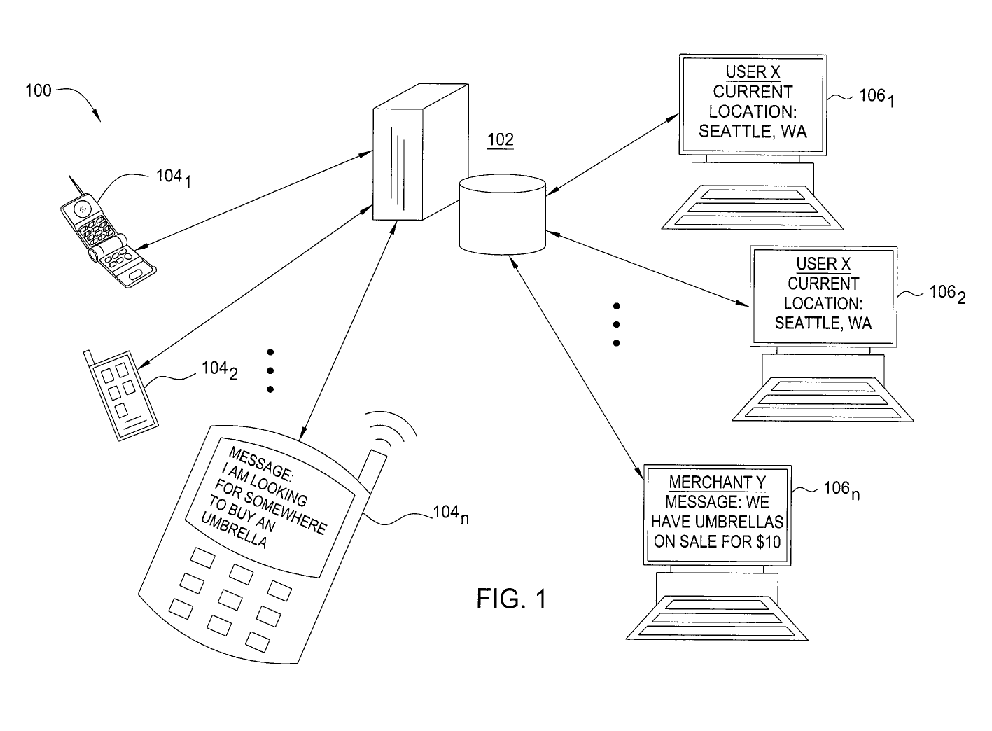

FIG. 1 is a schematic diagram illustrating one embodiment of a system 100 for providing personalized information in a dynamic manner, according to the present invention. As illustrated, the system 100 comprises an application 102 deployed in a service provider network, a plurality of consumer devices 104₁-104ₙ (hereinafter collectively referred to as “consumer devices 104”), and a plurality of commercial devices 106₁-106ₙ (hereinafter collectively referred to as “commercial devices 106”).

The consumer devices 104 comprise communication devices used by individual users (“consumers”). In one embodiment, the consumer devices 104 are mobile devices that are capable of communicating with other devices over a wireless network. For example, the consumer devices 104 may include mobile phones, smart phones, personal digital assistants, personal navigation devices, portable media players, netbooks, laptop computers, handheld computers, tablet computers, pagers, portable gaming devices, electronic book readers, or the like.

The commercial devices 106 comprise communication devices used by businesses such as retailers, service providers, or the like. For example, the commercial devices 106 may include application servers, desktop computers, mobile phones, smart phones, personal digital assistants, personal navigation devices, portable media players, netbooks, laptop computers, handheld computers, tablet computers, pagers, gaming consoles, set top boxes, portable gaming devices, electronic book readers, or the like.

The application 102 comprises a computer program that allows the users of the consumer devices 104 to publicize messages related to their needs. To this end, the application 102 comprises at least one server for hosting the application 102 and facilitating message publication and at least one database communicatively coupled to the server for storing information relating to the users of the application 102 (e.g., users of the consumer devices 104 and the commercial devices 106). In one embodiment, users of the consumer devices 104 and the commercial devices 106 subscribe to or register with the application 102 in order to gain access to the application 102. Thus, the database may store registration information (e.g., user names, passwords, profiles, or the like).

In operation, the system 100 allows users of the consumer devices 104 to broadcast their needs and to receive relevant advertisements responsive to the broadcasted needs from users of the commercial devices 106. In turn, the system 100 allows the users of the commercial devices 106 to identify and to communicate with individuals who are most in need of or who are most likely to purchase their products or services.

For instance, the user of the consumer device 104ₙ (e.g., a mobile phone) may get caught in a rain storm in Seattle. In this case, the user of the consumer device 104ₙ could send a message (e.g., a short messaging service message) to the application 102 that says “I am looking for somewhere to buy an umbrella.” In addition, the consumer device 104ₙ could automatically broadcast to the application 102 additional dynamic information related to the user and his or her needs. In one embodiment, the dynamic information includes, but is not limited to, the user's/consumer device's current location (e.g., as determined by a global positioning system), the time of day at the user's/consumer device's current location, a user profile associated with the user, or the like. Additionally, the consumer device 104ₙ could broadcast static information related to the user to the application 102, such as the user's contact information (e.g., email address, mobile phone number, etc.). Alternatively, the user of the consumer device 104ₙ could provide this information manually. Additionally, at least some of the static information could be stored by the application 102 (e.g., in the database).

The application 102 would then publish the message, along with at least some of the related information provided by the consumer device 104ₙ. In one embodiment, the application publishes the message and related information to a uniform resource locator that is accessible by users of the commercial devices 106. Users of the commercial devices 106 who believe that their products or services may be of use to the user of the consumer device 104ₙ may then respond with their own messages or advertisements, which are pushed to the consumer device 104. For instance, the user of the commercial device 106ₙ may own a convenience store in Seattle that sells umbrellas. He could respond with an advertisement that says “We have umbrellas on sale for ten dollars.” In addition, the commercial device 106ₙ could automatically broadcast the location of the convenience store, contact information for the convenience store, or other appropriate information along with the message. Alternatively, this information could be stored in a profile of the user of the commercial device 106ₙ which is maintained in the database of the application or by the commercial device 106ₙ.

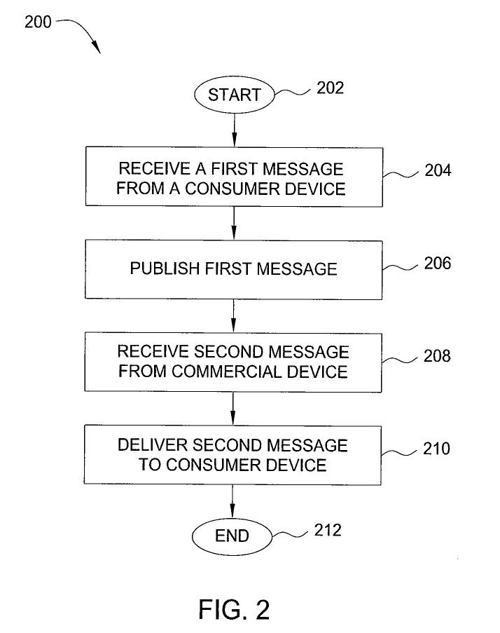

FIG. 2 is a flow diagram illustrating one embodiment of a method 200 for dynamically providing personalized information. The method 200 may be implemented, for example, at the application 102 illustrated in FIG. 1. As such, reference is made in the discussion of FIG. 2 to various components of the system 100. Those skilled in the art will appreciate, however, that the method 200 is not limited to use with the system 100 illustrated in FIG. 1 and may, in fact, be implemented within systems having alternative configurations.

The method 200 is initialized at step 202 and proceeds to step 204, where the application 102 receives a first message from a consumer device 104ₙ. The first message includes one or more of: a message directly input by the user of the consumer device 104ₙ (e.g., a text-, audio-, or video-based message) and other data broadcast by the consumer device 104ₙ (e.g., global positioning system data, time data, user profile data, or the like). The first message expresses some need of the user of the consumer device 104ₙ. This need may be a need for information, for products, or for services, for example. For instance, as discussed above, the first message may include a text-based message (e.g., a short messaging service message) stating “I am looking for somewhere to buy an umbrella.” In addition, the first message may include global positioning data indicating that the current location of the user of the consumer device 104ₙ is Seattle, Wash., and indicate that the user of the consumer device 104ₙ prefers stores that accept debit cards.

In step 206, the application 102 publishes the first message. In one embodiment, the published first message may also include direct contact information for the user of the consumer device 104ₙ (e.g., a phone number, an Internet Protocol address, an email address, or the like). In one embodiment, the first message is published to a uniform resource locator that is accessible by the commercial devices 106ₙ. This allows one or more merchants to view the first message.

In step 208, the application 102 receives a second message from a commercial device 106ₙ. The second message is a response to the first message sent by the consumer device 104ₙ. The second message includes one or more of: a message directly input by the user of the commercial device 106ₙ (e.g., a text-, audio-, or video-based message) and other data broadcast by the commercial device 106ₙ (e.g., global positioning system data, time data, user profile data, or the like). In one embodiment, the second message includes an advertisement that is relevant to the needs of the user of the consumer device 104ₙ (expressed in the first message).

For instance, continuing the example above, the second message may include a text-based message (e.g., a short messaging service message) stating “We have umbrellas on sale for ten dollars.” In addition, the second message may include the address of a convenience store at which the commercial device 106ₙ is based, and indicate that the convenience store accepts debit cards. As a different example, the second message may include a text-based message (e.g., a short messaging service message) stating “Come in from the rain and enjoy one of our daily lunch specials.” In addition, the second message may include the address of a restaurant at which the commercial device 106ₙ is based and a copy of the restaurant's menu.

In step 210, the application 102 delivers or pushes the second message to the consumer device related to the user and his or her needs. The method 200 then terminates in step 212.

In an alternative embodiment, the second message may be delivered directly to the consumer device 104ₙ by the commercial device 106ₙ (i.e., such that step 210 is unnecessary). For example, the commercial device 106ₙ may deliver the second message to a phone number specified in the contact information provided in step 206.

In one embodiment, the application 102 filters messages received from the consumer devices 104 such that they are published only to commercial devices 106 who may be capable of satisfying the consumer device user's needs. For example, if the consumer device user is currently in Seattle and needs an umbrella immediately, the application could publish the message to a uniform resource locator that is only accessible by commercial device users based in Seattle (or a limited radius surrounding Seattle). A commercial device user based in New Jersey, for example, may not be able to address the consumer device user's needs in a timely manner.

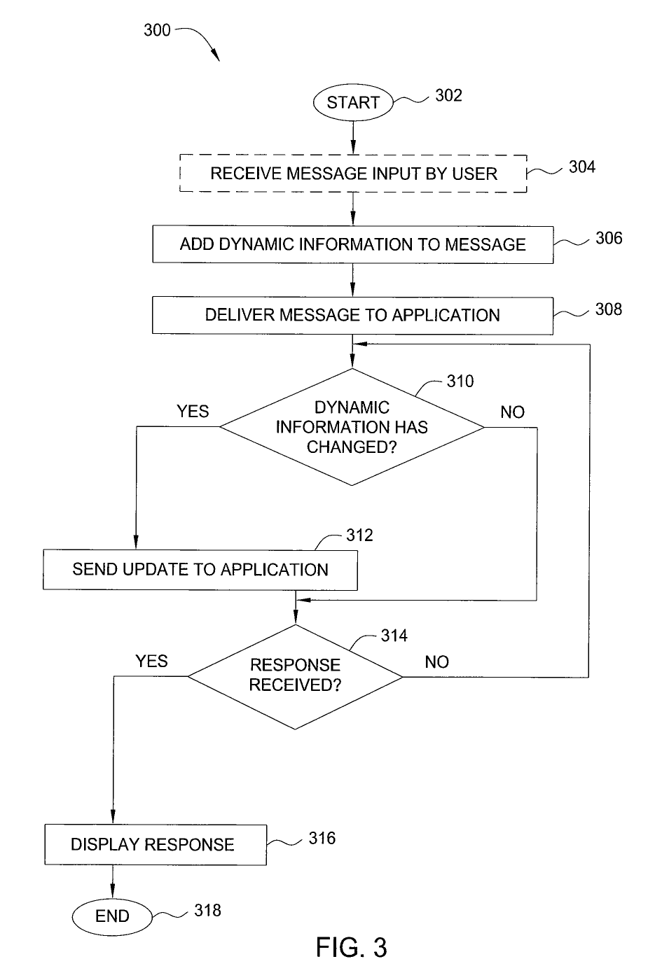

FIG. 3 is a flow diagram illustrating one embodiment of a method 300 for dynamically providing personalized information. The method 300 may be implemented, for example, at one of the consumer devices 104 illustrated in FIG. 1. As such, reference is made in the discussion of FIG. 3 to various components of the system 100. Those skilled in the art will appreciate, however, that the method 300 is not limited to use with the system 100 illustrated in FIG. 1 and may, in fact, be implemented within systems having alternative configurations.

The method 300 is initialized at step 302 and proceeds to optional step 304 (illustrated in phantom), where the consumer device 104ₙ receives a message input by a user. In one embodiment, the message is a text-, audio-, or video-based message that expresses a current need of the user.

In step 306, the consumer device 104ₙ adds dynamic information to the message. In one embodiment, the dynamic information includes at least one of: the consumer device's current location (e.g., as determined by a global positioning system), the time of day at the consumer device's current location, a user profile associated with the user, or the like. In one embodiment, the consumer device 104ₙ adds the dynamic information automatically. In another, embodiment, the dynamic information is manually inputted by the user of the consumer device 104ₙ.

In step 308, the consumer device 104ₙ delivers the message to the application 102. The method 300 then proceeds to step 310, where the consumer device 104ₙ determines whether the dynamic information has changed. For example, the consumer device's current location may have changed. In one embodiment, the consumer device 104ₙ determines whether the dynamic information has changed by a threshold amount (e.g., the current location has changed by at least x number of miles, or the time at the current location has changed by at least y minutes).

If the consumer device 104ₙ concludes in step 310 that the dynamic information has not changed (e.g., by the threshold amount), the method 300 proceeds to step 314, where the consumer device determines whether a response to the message (e.g., a response from a commercial device 106) has been received. In one embodiment, the response is received directly from the commercial device 106. In an alternative embodiment, the response is received from the commercial device 106 via the application 102, which acts as an intermediary.

Alternatively, If the consumer device 104ₙ concludes in step 310 that the dynamic information has changed (e.g., by the threshold amount), the consumer device 104ₙ sends an update to the first message with updated dynamic information to the application in step 312. The method 300 then proceeds to step 314 as discussed above.

If the consumer device 104ₙ concludes in step 314 that no response has been received, then the method 300 returns to step 310 and proceeds as discussed above.

Alternatively, if the consumer device 104ₙ concludes in step 314 that a response has been received, then the consumer device 104ₙ displays the response in step 316 before terminating in step 318.

In one embodiment, the user of the consumer device 104ₙ does not need to enter any content in order for a message to be sent to the application 102. The consumer device 104ₙ may instead automatically send messages on the user's behalf, based, for example, on information in a user profile and/or dynamic information monitored by the consumer device 104ₙ. For instance, the user profile may specify certain trigger conditions that, when met, cause the consumer device 104ₙ to send a message (e.g., “Send a message to locate local coffee shop at 8:00 AM”).

This also allows the consumer device 104ₙ to dynamically update the message over time (e.g., on a periodic of continuous basis), so that any responses received are still timely and relevant. That is, the message is not static, but dynamically changes in response to the user's changing needs. For instance, referring again to the example above, the message about the user needing an umbrella may be updated as the user's location (and, consequently, the consumer device's location) changes with time. A convenience store that was close 20 minutes ago may no longer be as close, and there may now be better places to purchase an umbrella.

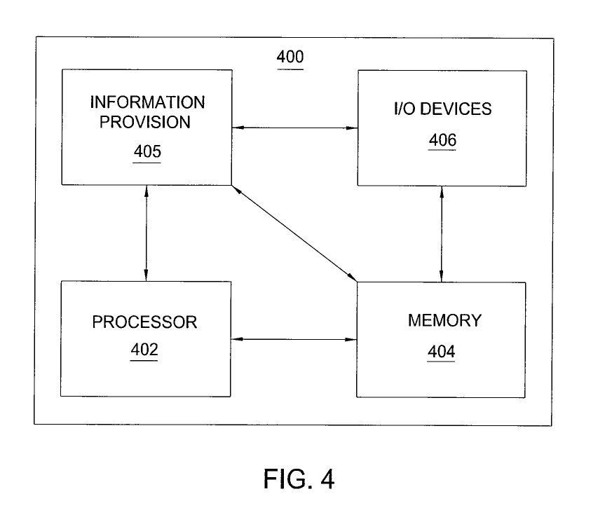

FIG. 4 is a high level block diagram of the information providing method that is implemented using a general purpose computing device 400. In one embodiment, a general purpose computing device 400 comprises a processor 402, a memory 404, an information provision module 405 and various input/output (I/O) devices 406 such as a display, a keyboard, a mouse, a modem, a stylus, a joystick, a keypad, controller, a barcode scanner, and the like. In one embodiment, at least one I/O device is a storage device (e.g., a disk drive, an optical disk drive, a floppy disk drive). It should be understood that the information provision module 405 can be implemented as a physical device or subsystem that is coupled to a processor through a communication channel.

Alternatively, the information provision module 405 can be represented by one or more software applications (or even a combination of software and hardware, e.g., using Application Specific Integrated Circuits (ASIC)), where the software is loaded from a storage medium (e.g., I/O devices 406) and operated by the processor 402 in the memory 404 of the general purpose computing device 400. Thus, in one embodiment, the information provision module 405 for dynamically providing personalized information described herein with reference to the preceding Figures can be stored on a computer readable storage medium (e.g., RAM, magnetic or optical drive or diskette, and the like).

It should be noted that although not explicitly specified, one or more steps of the methods described herein may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in the accompanying Figures that recite a determining operation or involve a decision, do not necessarily require that both branches of the determining operation be practiced. In other words, one of the branches of the determining operation can be deemed as an optional step.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for providing information relevant to a need of a user of a communication device, the method comprising:
monitoring, by the communication device, dynamic information relating to the need of the user; and
sending, by the communication device, a message describing the need of the user, where the message comprises the dynamic information.

2. The method of claim 1, further comprising:
receiving a response to the message; and
displaying the response.

3. The method of claim 1, wherein the sending comprises sending the message to a remote application.

4. The method of claim 3, the application publishes the message to a uniform resource locator.

5. The method of claim 1, wherein the dynamic information comprises at least one of: a current location of the communication device, a time of day at the current location of the communication device, or a user profile associated with the user.

6. The method of claim 1, wherein the message further comprises content input by the user.

7. The method of claim 1, wherein the content comprises at least one of: a text-based message, an audio-based message, or a video-based message.

8. The method of claim 1, wherein the communication device dynamically updates the message over time.

9. The method of claim 1, wherein the communication device is a mobile device.

10. A computer readable storage medium containing an executable program for providing information relevant to a need of a user of a communication device, where the program performs steps of:
monitoring, by the communication device, dynamic information relating to the need of the user; and
sending, by the communication device, a message describing the need of the user, where the message comprises the dynamic information.

11. The computer readable storage medium of claim 10, further comprising:
receiving a response to the message; and
displaying the response.

12. The computer readable storage medium of claim 10, wherein the sending comprises sending the message to a remote application.

13. The computer readable storage medium of claim 12, the application publishes the message to a uniform resource locator.

14. The computer readable storage medium of claim 10, wherein the dynamic information comprises at least one of: a current location of the communication device, a time of day at the current location of the communication device, or a user profile associated with the user.

15. The computer readable storage medium of claim 10, wherein the message further comprises content input by the user.

16. The computer readable storage medium of claim 10, wherein the content comprises at least one of: a text-based message, an audio-based message, or a video-based message.

17. The computer readable storage medium of claim 10, wherein the communication device dynamically updates the message over time.

18. The computer readable storage medium of claim 10, wherein the communication device is a mobile device.

19. Apparatus for providing information relevant to a need of a user of a communication device, the system comprising:
means for monitoring, by the communication device, dynamic information relating to the need of the user; and
means for sending, by the apparatus, a message describing the need of the user, where the message comprises the dynamic information.

20. The apparatus of claim 19, wherein the apparatus is a mobile communication device.
